(19) United States
(12) Patent Application Publication
(10) Pub. No.: US 2019/0203059 A1
(43) Pub. Date: Jul. 4, 2019

(54) Enclosure Structure Device for Process Furnaces

(71) Applicant: OBSCHESTVO S OGRANICHENNOI OTVETSTVENNOSTYU "INTEKHENERGO", Volzhsky (RU)

(72) Inventor: Alexander V. Shevtsov, Volzhsky (RU)

(21) Appl. No.: 16/302,641

(22) PCT Filed: May 15, 2017
(86) PCT No.: PCT/RU2017/050039

§ 371 Date: Nov. 17, 2018

(30) Foreign Application Priority Data
May 19, 2016 (RU) 2016119411

(51) Int. Cl. C09D 5/18; C09D 7/61; C09D 7/40; F27D 1/00

(52) U.S. Cl. CPC C09D 5/18; F27D 1/0033; C09D 7/70; C09D 7/61

(57) ABSTRACT

The current invention relates to the field of process furnaces design and can be used in oil refining industry, steam boilers and furnaces for heating feedstocks. A body of a process furnace, comprising an internal lining, is also provided with an outer protective coating which is discrete and structurally heterogeneous. The irregularity of the coating structure is provided by a filler. The invention makes it possible to reduce fuel consumption by reducing heat emission and heat loss from a furnace body into the surrounding environment.

### CROSS-REFERENCE TO RELATED APPLICATIONS

The present application is a CIP National phase application of PCT/RU2017/050039 filed May 15, 2017, which claims priority to Russian application 2016119411 filed May 19, 2016, both the PCT and Russian applications being incorporated herein by reference in their entirety.

### BACKGROUND OF THE INVENTION

### 1. Field of the Invention

The present technical design relates to the structure of the body of process furnaces (PF) and can be used for the enclosure structures of PF for reforming, steam boilers, furnaces for heating up starting materials. The design ensures decrease of fuel consumption due to lowering heat transfer from the PF body into environment.

Known PF designs contribute to some extent to lowering heat transfer from the PF body to the environment, mainly due to using internal lining. However, as it follows from the below description of prior art, the problem of lowering fuel consumption for compensating heat loss from the body has not been solved. Increasing thickness of the furnace lining results in either decreasing the internal space of the furnace leading to the output reduction or in the increase of outer dimensions of the furnace resulting in the increase of the cost of the PF.

### 2. State of the Art

Known in the art are tubular heating furnaces according to P [symbol] 3688-00220302-003-04 (Regulatory document for operational requirements to tubular heating furnaces, 2004). A tubular furnace comprises: equipment (product coils, coils for producing and/or overheating steam vapor, air heaters), suspenders, racks and supports for coils; burner arrangements (using gas fuel, residual fuel oil or composite fuel); fittings (access hatches, explosion relief flanges, gates); heat barriers (lining, thermal); support and enclosure metal structures; stairs, interstair paces, gas pipes, air ducts, piping systems, chimney shafts; draught systems (fans and kiln fans).

When estimating the thickness of the lining and thermal of the furnace body, gas pipes, air ducts, and piping systems, it is assumed that the design temperature on the outer surface of the above elements is secured to be such as to meet the accepted value of the technical and economic indexes of the furnace and safety requirements.

The estimation of heat loss through the furnace casing is to take into account the air temperature equal to the average yearly air temperature at the location of the furnace and surface heat-transfer coefficient of 35 kc/m²h° C.

The outside surface temperature of any surface element at the servicing zone must not exceed 60° C. Outside the limits of the operational and servicing zones of the furnace, the surface temperature of any element can rise to 80° C. at the average maximum temperature of the hottest month at the location of the furnace.

The disadvantage of this design lies in large heat loss from the furnace body. Specifically, even at the minimum permissible temperature of the PF of 60° C. a “standardized” fuel consumption to compensate for the heat loss from the body exceeds 5% of the total consumption.

Known has been Russian utility model patent 130664 “Multilayer heat isolation”. The multilayer heat isolation comprises a prime coat including a water-ceramic composition of the “Hot Pipe Coating” brand, at least one first heat-insulating layer including a water-ceramic composition of the “Hot Pipe Coating” brand placed onto the prime coat, and following heat-insulating layers including water-latex ceramic composition of the “Temp-Coat” brand placed on each other by their respective surfaces and placed by the surface of the second layer thereof on the surface of at least the one first heat-insulating layer.

This design suffers from heaviness of the isolation structure, inability of the constant monitoring of the PF surface under the multilayer coating, as well as from the isolation repair complexity and short life of this type of coating.

A plurality of [relevant] patents has been known in the art:

RU 2304600C2, C09B 5/02, of Aug. 20, 2007. The design of an anti-corrosive and heat-insulating coating for pipelines uses a composition filled with hollow microspheres. The invention relates to chemical industry and means used for anti-corrosive and overheat protection of various surfaces, specifically metallic, concrete and plastered surfaces, as well as other engineering structures of metal and concrete operating in hostile environment, especially for the thermal isolation and corrosive protection of pipelines, including the thermal isolation of heat and water supply pipelines.

RU 250276301, C09b 5/02, of Dec. 27, 2013 related to anti-corrosive and thermal isolation coating made of a water-turbid composition with viscosity from 1 up to 100 Pa·s and including a mixture of a polymer binder (5-95 vol. %) and hollow microspheres as a filler (5-95 vol. %).

RU 2311397C2, C04B 41/48, of Nov. 27, 2007. A composition for thermal isolation coating comprising hollow ceramic microspheres as a filler, a polymer binder, a processive additive and water is characterized in that it comprises hollow microspheres as the filler and comprises latex as the polymer binder.

All the above patents relate to the structure and composition of liquid-ceramic materials proposed by the inventors for thermal isolation of, for example, PF.

A PF comprises a metallic (rarely brick or concrete) body and internal lining. Using liquid-ceramic and other thermal isolation materials for heat isolation of the PF outside the body thereof results in a number of problems.

Particularly, where rockwool or foamed polyurethane coating are used for the outside protection, visual control of the furnace body surface condition is impossible. Industry-specific regulations for maintaining fire potential equipment require having constant visual monitoring of the PF body surface condition. Additionally, load upon the body increases, and the temperature of the body under the isolation rises.

Where liquid-ceramic materials are used for the PF outside-the-body isolation, the body temperature increases. Heat conductivity factor of 0.003 to 0.001 W/m ° C. disclosed in the specifications of liquid-ceramic materials provides thermal resistance of a layer of 3.0 mm to be no less than 1.0 m²° C. This increase of the thermal resistance of the last layer results in the increase of the PF body temperature by more than 100° C. Proportionally increasing is the temperature of the internal lining. Overheating the lining and the body cover decreases operational lifetime of the PF.

Also, those liquid materials fail to meet the requirements of fire safety regulations for explosion-hazardous production facilities.

### BRIEF SUMMARY OF THE INVENTION

The task intended to be solved by the proposed invention lies in modifying the structure of the PF body outside surface to thus lower the heat transfer from the surface into the environment due to decreasing heat radiation and convective heat transfer.

The technical result of the proposed invention resides in lowering heat loss from the PF body.

The above technical result is achieved in the proposed enclosure structure for a body of a process furnace, which comprises a body with a frame and an internal lining, by means of providing the body on an outside surface thereof with a discrete coating, heterogeneous by the structure thereof, the coating comprising water and a mixture of acrylic polymers and dispersed fillers, the mixture containing 40-70 vol. % and water containing 60-30 vol. % of the total volume.

Specifically, the filler can include expanded perlite. Understood by perlite in the present specification is an amorphous volcanic glass that has a relatively high water content, typically formed by the hydration of obsidian. It occurs naturally and has the unusual property of greatly expanding when heated sufficiently. It is an industrial mineral and a commercial product useful for its low density after processing (https://en.wikipedia.org/wiki/Perlite). In a particular case, the term microsphere is applied to a finished product.

Also, the filler can include microspheres.

Additionally, thickness of the coating is between 0.4 to 2 mm.

A composition is applied from the outside of the PF enclosure, the composition comprising the filler (for example, microspheres, expanded perlite, etc.).

Compositions of a mixture of acrylic polymers (28% wt), water (47% wt) and fillers—oxides of calcium, silicon and titanium (total 25% wt) dispersed in the composition may serve as an example thereof. Or compositions of a mixture of latexes (65-75% wt) and expanded perlites (calcium and titanium oxides, 35-25% wt) dispersed therein. Or, for example, compositions of a mixture of latexes (65-75% wt) and microspheres (silicon oxides, 35-25% wt) dispersed therein.

Formed upon solidification of the composition is a layer of an entire coating having lower heat transfer and heat conductivity coefficients, as compared to those of the body and frame materials.

Compositions of water and a mixture of acrylic polymers and fillers dispersed therein (and containing from 40 up to 70% of the volume of the whole composition), a mixture of latexes and expanded perlites dispersed therein (and containing from 40 up to 70% of the volume of the whole composition), or, for example, a mixture of latexes and microspheres dispersed therein (and containing from 40 up to 70% of the volume of the whole composition) may serve as examples of such compositions.

The resulting layer of a coating formed on the body surface has lower heat transfer and heat conductivity coefficients in contrast with those of the body and frame materials.

With the maximum permissible thickness of the coating of 0.2 mm in view, it is only due to the presence of the filler in the coating that allows for lowering heat transfer from the surface of the material. By properties, the resulting surface is discrete rather than entire (solid). As compared with a solid structure of a material, a discrete one has lower heat transfer and heat conductivity. At the same time, the mentioned thickness of the coating prevents the PF body metal from overheating and does not get in the way of controlling the body condition visually. A number of fire safety requirements with regard to the structure are met herewith as well.

### BRIEF DESCRIPTION OF DRAWINGS

Details, features and advantages of the present invention will be explained in the ensuing description of the embodiments thereof and accompanying drawings, in which:

FIG. 1 illustrates an example of an enclosure structure of the body of the PF for heating up starting materials;

FIG. 2 shows an example of an enclosure structure of the body of the PF for primary crude oil processing;

FIG. 3 depicts an example of an enclosure structure of the body of the PF for heating up starting materials with an additional protective coating; and

FIG. 4 reflects an example of an enclosure structure of the body of the PF for primary crude oil processing with an additional protective coating;

Denoted in the drawings are the following positions: 1—a body of the furnace; 2—an outside frame; 3—an integrated structure of the internal lining and thermal; 4—an outer coating of the body and frame of the furnace with a discrete composition, heterogeneous by the structure thereof, the composition having thickness of no more than 2.0 mm and comprising, for example, water and a mixture of acrylic polymers and fillers dispersed therein and comprising 40-70% of the volume of the whole composition.

### DETAILED DESCRIPTION

The technical solution relates to the body of process furnaces (PF) and can be used at the metallurgic, chemical and petroleum refining facilities for energy usage reduction and enhancement of the personnel's safety, as well as for additional protection of the PF metallic frame from unfavorable environment factors. Designs of the PF known in the art conduce, to a degree, and mainly due to the use of internal lining, the lowering of heat transfer from the body of PF. However, as it follows from the analysis of the prior art, the problem of decreasing the fuel consumption to compensate for the heat loss from the body has not yet been solved. Increasing the thickness of the furnace lining results in either decreasing the internal space of the furnace leading to the reduction of the output thereof, or in the increase of outer dimensions of the furnace resulting in the increase of the cost of the PF.

In the proposed invention, a discrete composition, heterogeneous by structure thereof and no more than 2.0 mm in thickness, is applied to an outside surface of the enclosure structure (the PF body).

Compounds comprising water and a mixture of acrylic polymers and fillers dispersed therein and making from 40 to 70% of the whole composition, or a mixture of latexes and expanded perlites dispersed therein (from 40 to 70% of the whole composition), or a mixture of latexes and microspheres dispersed therein (from 40 to 70% of the whole composition) can be cited as examples of such products.

Developed at the surface of the body after the polymerization of the compound is a layer of a discrete, heterogeneous coating possessing, as compared with the materials of the PF body and frame, lower heat transfer and heat conductivity.

The minimal thickness of the coating is limited by the spreading capacity of the composition of the coating. For example, for compositions using microspheres as a filler, the spreading capacity is no less than 0.2 mm, whereas it is no less than 0.4 mm for those using expanded perlite as a filler. Maximal thickness of the coating, namely 2.0 mm, is limited by fire safety regulations for particularly hazardous facilities.

Where the mixture filler is less than 40% of the whole composition, discrete properties of the coating surface sharply deteriorate. In case it is more than 70%, linear stretching of the finished coating decreases, thus lowering service time of the coating.

It is only where the quantity of the polymers and fillers is between 40 and 70% that the heat transfer from the surface of the material decreases. Formed is a discrete surface rather than the entire one. The discrete structure of the material has lower heat transfer and conductivity as compared with the entire one. At the same time, the above-identified thickness of the coating prevents the PF body metal from overheating and does not get in the way of controlling the condition of the body visually. Also, a number of fire safety requirements with regard to the PF structure are met herewith as well.

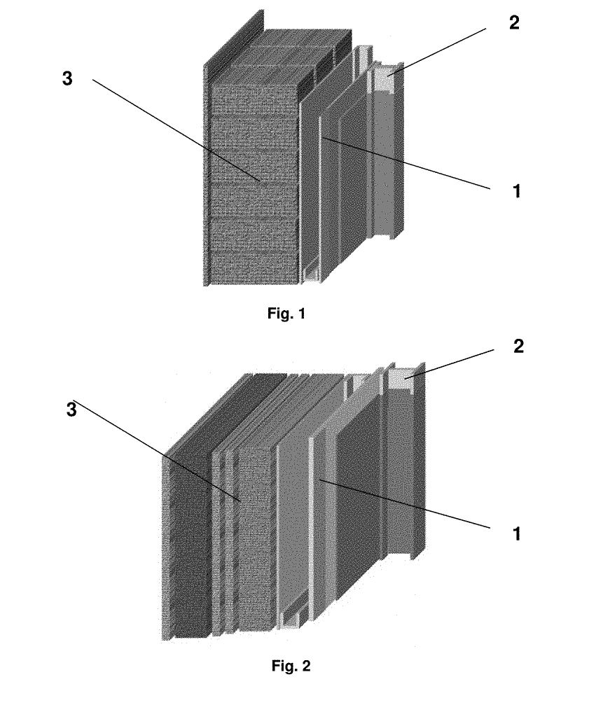

FIG. 1 exemplifies the PF structure for heating up starting materials.

The enclosure structure of this PF comprises a layer of internal lining of fire-brick protected from inside by a thermostable filler. There is also an integrated structure of a steel casing of the body and frame. The steel casing of the body and frame is covered with an antirust compound and a protective enamel. Brands and technical characteristics of the materials used for the PF, which depend on the PF operation condition requirements, vendor capacity, and the cost of the materials used, have no impact on the proposed design.

FIG. 2 shows an example of the PF structure used for primary crude oil processing.

The enclosure structure of this PF comprises a layer of internal lining of mineral wool mats protected from inside by a thermostable filler and layers of thermal from mineral wool boards. There is also an integrated structure of a steel casing of the body and frame. The steel casing of the body and frame is covered with an antirust compound and a protective enamel. Brands and technical characteristics of the materials used for the PF, which depend on the PF operation condition requirements, vendor capacity, and the cost of the materials used, have no impact on the proposed design.

In both above examples, the end element is the steel casing. It is known that steel has high value of heat transfer, and protection paint does not decrease the value of heat transfer.

Heat transfer coefficient is a value characterizing the rate of heat dissipation, and it is defined by the ratio of the current of heat released by a surface to the temperature difference between this surface and adjacent environment. A design heat transfer coefficient, according to the Building code (CNR (Construction Norms and Rules) 2.04.14-88, as applied, appendix 9) is equal to 35 W/m²° C.

An open metallic (or brick or concrete) surface possesses high value of the heat transfer coefficient which is due to physical properties of the materials used for the PF body. The object of the proposed design is to change physical structure of the outer heat dissipating surface that would result in decreasing heat transfer therefrom. In doing so, the possibility of visual monitoring of the PF body surface condition should be kept, and the overheating of the body should be avoided.

Generally, the enclosure structure comprises three basic elements—a body, a frame securing the integrity of the body, and an internal lining (potentially with thermal elements). In some cases, a strengthened design of the lining, such as in open-hearth furnaces, serves as the body and frame as well.

Unlike the traditional body structure comprising the internal lining (thermal) and body with frame, the proposed PF enclosure structure comprises four elements: a body 1, a frame 2, an aggregate 3 of internal lining and thermal, and an outer protective coating 4, no more than 2.0 mm in thickness, formed by a discrete composition, heterogeneous by structure thereof, such as water and a mixture of acrylic polymers and fillers dispersed in water and containing from 40 to 70% of the total volume of the composition.

Examples of these compositions are water and a mixture of acrylic polymers and fillers dispersed therein and containing from 40 to 70% of the total volume of the composition; or water and a mixture of latexes and expanded perlite (the mixture containing from 40 to 70% of the total volume of the composition) dispersed therein; or water and a mixture of latexes and microspheres (from 40 to 70% of the total volume of the composition) dispersed therein.

Due to lower, as compared with that of the material of the PF body, heat transfer and heat conductivity of the additional coating of the enclosure structure of the PF, heat loss from the body and frame of the PF into the atmosphere decreases. Thus, the proposed design results in lowering fuel consumption to compensate for the heat loss from the PF body into surrounding air.

The maximal thickness of the protective coating, equal to 2 mm, is limited by the necessity to assure visual monitoring of the condition of the PF surface.

The limiting of the volume of the polymers and filler used in the protective coating to 40-70% of the total volume results from the finding that if their volume is less than 40%, the decrease of the heat transfer from surface is insufficient and does not outweigh the prior expenses, whereas where the volume of the mixture of polymers and filler is more than 70% of the total volume, the capacity of the protective coating to linear stretching decreases, resulting in the destruction of such coating after the furnace shutdown.

A mixture of butadiene-styrene latex, acrylic polymers, ammonia, and water with a mixture of such fillers as expanded perlite, quartz, zinc oxide and titanium dioxide can serve an example of the composition of the protective coating according to the proposed design.

Weight percentage of a solvent (water) is 47%, weight percentage of nonvolatile substances is 53%, the latter comprising 23% of polymeric components and 28% of noncombustible inorganic components, the nonvolatile inorganic components comprising 25% of silicon oxide, 28% of titanium oxide, 19% of calcium oxide, 20% of zinc oxide, 5% of potassium oxide, and 3% of ferrous oxide.

It was established as a result of the research of the characteristics of the protective coating of the above-identified composition that the density of the coating is 410 kg/m³; specific heat capacity is 1.120 kJ/kg ° C.; the coefficient of heat transfer is 2.0-3.0 W/m²° C.; coating combustibility—CC1.

For comparison, the coefficient of heat transfer from a metallic surface to surrounding air, according to the Building code (CNR 2.04.14-88, as applied, appendix 9) is equal to 35 W/m²° C.

Compared below are two variants of calculation of heat loss from the PF body—without the protective coating and with the same.

Variant 1 with no protective coating (FIG. 1).

Heat transfer resistance

$$R = \frac{1}{α1} + \frac{δ}{λ} + \frac{1}{α2} ,$$

where
α1—heat absorption coefficient—50 W/m²° C.
δ—thickness of the enclosure structure—0.2 m
λ—average heat conductivity coefficient for the whole enclosure structure—1.0 W/m²° C.
α2—coefficient of heat transfer from the surface—35 W/m²° C.
R—design resistance to heat transfer—0.25 m²° C./W.

Heat loss from the structure under consideration

$$- q = \frac{t - t 3}{R} ,$$

where
t—ambient temperature inside the furnace—800° C.
t3—temperature of surrounding air—0° C.
q—design heat loss—3144 W/m².

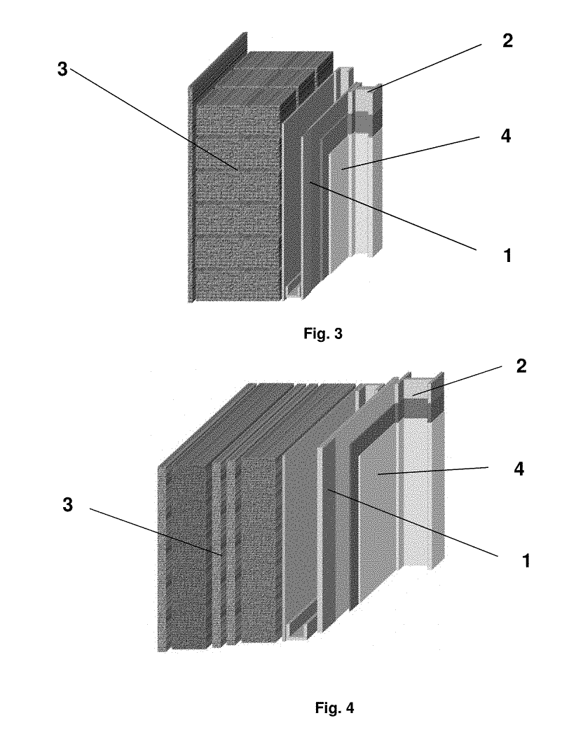

Variant 2 with protective coating (FIG. 3).

Note: to simplify the comparable estimation, the change of thickness of the enclosure structure and of the heat conductivity resulting from applying the protective coating is not taken into account.

Heat transfer resistance

$$R = \frac{1}{α1} + \frac{δ}{λ} + \frac{1}{α2} ,$$

where
α1—heat absorption coefficient—50 W/m²° C.
δ—thickness of the enclosure structure—0.2 m
λ—average heat conductivity coefficient for the whole enclosure structure—1.0 W/m²° C.
α2—coefficient of heat transfer from the surface—3.0 W/m²° C.
R—design resistance to heat transfer—0.55 m²° C./W.

Heat loss from the structure under consideration

$$- q = \frac{t - t 3}{R} ,$$

where
t—ambient temperature inside the furnace—800° C.
t3—temperature of surrounding air—0° C.
q—design heat loss—1446 W/m².

The change of heat transfer of the enclosure structure of the PF makes it possible to have heat loss from the PF body 2.2 times lower.

1. An enclosure structure for a body of a process furnace comprising the body with a frame and an internal lining structure, characterized in that the body is covered from an outer surface thereof with a coating which is discrete and heterogeneous by structure and which comprises a mixture of polymers dispersed in water and fillers, the fillers being from 40 to 70% of the volume of the mixture.

2. The body per claim 5, wherein the fillers include expanded perlite.

3. The body per claim 5, wherein the fillers include microspheres.

4. The body per claim 5, wherein thickness of the outer coating is from 0.4 to 2.0 mm.

5. A body of a process furnace comprising an internal lining therein and an outer coating thereon, the coating comprising a mixture of water (from 60 to 30 vol. %) and polymers with fillers (from 40 to 70 vol. %).
